(19) United States
(12) Patent Application Publication
(10) Pub. No.: US 2005/0134181 A1
(43) Pub. Date: Jun. 23, 2005

(54) Pulsed high-power flash lamps made of compound quartz glass tubes and process for manufacture thereof

(76) Inventors: Baocai Jang, Shanghai (CN); Haibing Li, Shanghai (CN); Cailai Yuan, Shanghai (CN); Wenzheng Lin, Shanghai (CN); Jianhua Yu, Shanghai (CN)

Correspondence Address: RABIN & BERDO, P.C.;Suite 500, 1101 14 Street, N.W., Washington, DC, 20005, US

(21) Appl. No.: 11/012,207

(22) Filed: Dec. 16, 2004

(30) Foreign Application Priority Data
Dec. 19, 2003 (CN) 200310122620.4

(51) Int. Cl. H01J 17/16; H01J 7/24

(52) U.S. Cl. 313/636; 313/635; 313/489

(57) ABSTRACT

The invention concerns a pulsed high-power compound quartz tubes flash lamp and process for manufacture. One of the most important characteristics of the present invention is that the flash lamp envelope is made of compound fused quartz glass tubes which comprises one or multilayer pure fused quartz glass layer and one or multilayer Ce-doped fused quartz glass layer. Said manufacture process comprising: 1) forming a compound quartz glass lump, 2) heating the compound quartz glass lump in intermediate frequence furnace to manufacture compound quartz glass tubes, 3) sealing electrodes in compound quartz glass tubes, 4) vacuumizing the compound quartz glass tubes and immitting gases to fabricate a pulsed high-power flash lamp.

### FIELD OF THE INVENTION

The invention relates generally to pulsed high-power flash lamps which is used in solid-state lasers and more specially to pulsed high-power flash lamps made of compound quartz glass tube.

### DESCRIPTION OF PRIOR ART

Pulsed high-power xenon flash lamp is a kind of excellent optical pumping sources for solid-state lasers because flash lamp can provide extremely intense and short light pulse. Large solid-state lasers used to drive inertial confined fusion must generate megajoule pulse output. So more excellent properties for pulsed high-power xenon flash lamps are required. Now very high-power xenon flash lamps present several challenges to long-life operation and proper emission spectrum. When xenon flash lamps are discharging, strong currents generate tremendous magnetic fields and xenon plasmas that hammer and even destroy the quartz glass envelope of the lamps. At the same time, xenon plasmas produce ultraviolet radiation below 340 nm that will lead to generate inner defects in the Nd:glasses. So high-power solid-state laser requires not only that the quartz glass envelope of the flash lamps has good mechanical properties to increase loading energy of xenon flash lamps, but also appropriate emission spectrum of xenon flash lamp that matches absorption spectrum of Nd:glasses. It has been proven that prior art pulsed xenon flash lamp made of pure fused quartz tubes or Ce-doped fused quartz tube cannot satisfy such requirements.

Ultimate energy of pulsed xenon flash lamp is that maximum energy that flash lamp can discharge in a single flash without fragmentation (catastrophic failure). The empirical expression derived for the ultimate energy of linear xenon flash lamp is given by
Eₓ=12ld\sqrt{τ} (1)
here l is the arc length, d is the bore diameter and τ is the duration of the current pulse, when l and d are expressed in centimeters and τ in microseconds, Eₓ is expressed in joules. Moreover, there is an empirical relationship between the energy input E₀ and the shot life N as

$$N = {( \frac{{E}_{0}}{{E}_{x}} )}^{β} \qquad ( 2 )$$
here β is a load coefficient which relates to the bore diameter. Eₓ of the specification φ37 (thickness:3 mm)×1430 mm pulsed xenon flash lamp made of Ce-doped fused quartz tube is 124700J (measured by Institute of Shanghai Optics and Fine Mechanics, Chinese Academy of Sciences). According to expression (2), it is easy to obtain the shot life N of this specification pulsed xenon flash lamp in different discharge conditions.

Conventional pulsed high-power flash lamp is made of pure fused quartz glass tubes (hereinafter referred to as pulsed high-power pure quartz tube flash lamp) or Ce-doped fused quartz glass tube (hereinafter referred to as pulsed high-power Ce-doped quartz tube flash lamp). Although it possesses excellent mechanical properties such as shock wave and heat shock wave resistence and high loading energy, pulsed high-power pure quartz tube flash lamp cannot absorb ultraviolet radiation of xenon plasma below 340 nm which will induce to generate inner defects in the Nd:glass. So this kind of flash lamp is abandoned in very high-power solid-state lasers such as large solid-state lasers used to drive inertial fusion energy reactors either in china or abroad now. On the contrary, Ce-doped fused quartz glass tube is doped with some impurities (such as CeO₂, Al₂O₃, TiO₂) in pure fused quartz tubes and it strongly absorbs ultraviolet radiation of xenon plasma below 340 nm, but doped impurities (CeO₂, Al₂O₃, etc) in silica glass will reduce mechanical strength of silica glass tubes. So pulsed high-power Ce-doped quartz tube flash lamp has excellent emission spectrum, but its the explosion energy is lower than that of pure fused quartz tubes flash lamp and its life time decreases.

Flash lamps require its envelope can absorb ultraviolet radiation of plasma below 340 nm however donot decrease transmittance of visible light. To reach the require, JP-63-313253 discloses a method which provide this kind of quartz glass tube by coating Cerium solution and Silicon solution at innner surface or outer surface of quartz glass tube and sintering tube at temperature between 500° C. and 800° C. to form a Ce-doped quartz film at surface of quartz glass tube. The Ce-doped quartz film can absorb ultraviolet radiation of plasma below 340 nm. However this kind of film is very thin (10² μm), the binding strength between film and surface of tube is loose, the film is easy to be destroied.

JP-63-1961273 discloses a method which provide a flash lamp that absorb ultraviolet radiation of plasma below 340 nm by adding a Ce-doped quartz glass tube as a outer tube out of qurartz glass tube flash lamp. Lamps provided by the method have some disadvantage, such as incompact structure, big bulk and bad mechanical properties, so the lamps are easy to be destroied.

### SUMMARY OF THE PRESENT INVENTION

It is therefore an object of the present invention to effectively overcome the disadvantage of the prior art and provide a pulsed high-power flash lamp made of compound quartz glass tubes (hereinafter referred to as pulsed high-power compound quartz tube flash lamp) and process for manufacture thereof. The advantage of the present invention is that a pulsed high-power flash lamp provided that possesses not only excellent mechanics properties, high loading energy and a long operating life time, but also appropriate emission spectrum which the ultraviolet radiation of below 340 nm can be strongly absorbed.

The technical approad of the present invention is as follows:

Briefly, a pulsed high-power flash lamp embodiment of the present invention comprises a fused quartz flash lamp envelope. Each end necks down to a smaller diameter to accommodate an anode re-entrant seal assembly at one end and a cathode re-entrant seal assembly at the other end. One of the most important characteristics of the present invention is that the flash lamp envelope is made of compound fused quartz glass tubes which comprises one or multilayer pure fused quartz glass layer and one or multilayer Ce-doped fused quartz glass layer.

The compound fused quartz glass tubes of the present invention comprises one or multilayer pure fused quartz glass layer and one or multilayer Ce-doped fused quartz glass layer, pure fused quartz glass layer and Ce-doped fused quartz glass layer alternately arrayed. The concentration of Cerium ion in Ce-doped fused quartz glass layers is uniform, or variational.

The compound quartz glass tubes of the present invention comprises two layer quartz glass, inner layer is pure fused quartz glass layer and outer layer is Ce-doped fused quartz glass layer, or inner layer is Ce-doped fused quartz glass layer and outer layer is pure fused quartz glass layer.

The compound quartz glass tubes of the present invention comprises one pure quartz glass layer and multilayer Ce-doped quartz glass layer, inner layer is pure fused quartz glass layer, and other layers are Ce-doped fused quartz glass layer.

A process for the manufacture a pulsed high-power compound quartz tube flash lamp of the present invention, said process comprising:
1) Melting undoped and doped quartz raw material at a temperature at least 2000° C. in a oxyhydrogen flame or plasma flame according to layer configuration of a compound quartz glass tubes to form a compound quartz glass lump,
2) Heating the compound quartz glass lump in intermediate frequence furnace to manufacture compound quartz glass tubes,
3) Sealing a cathode electrode and a anode electrode in compound quartz glass tubes by sealed technics,
4) vacuumizing the compound quartz glass tubes and immitting gases to fabricate a pulsed high-power compound quartz tube flash lamp.

The flash lamp of the present invention can be fabricated with different seal technics, such as matched seal technics, non-matched seal technics.

Compared to the prior art, the key of the present invention is that the present invention uses compound quartz tubes as the envelope of flash lamp. Melting undoped and doped quartz raw material at a temperature at least 2000° C. in a oxyhydrogen flame or plasma flame to form a compound quartz glass lumps, pure quartz glass layer and Ce-doped quartz glass layer entirely melted and integrated. So the compound quartz tubes possesses not only excellent mechanical strength like pure quartz tubes but also appropriate transmission spectra which are similar to that of Ce-doped fused quartz glass tubes. So the advantage of the present invention is that the flash lamp possesses excellent mechanical and loading energy properties. Another advantage of the present invention is that the flash lamp possesses appropriate emission spectruml property that is, it can cut off near ultraviolet radiation near 320 nm effectively, so it can match well absorption spectrum of Nd:glass.

### BRIEF DESCRIPTION OF THE DRAWINGS

FIG. 1 is a cutaway cross-sectional view of a flash lamp embodiment of the present invention.

FIG. 2 is a schematic diagram of the configuration of compound quartz tube.

FIG. 3 is the transmission spectra in the wavelength range from 200 nm to 800 nm in pure quartz glass (A), in Ce-doped quartz glass (B) and in compound quartz glass applied in this invention (C).

FIG. 4 is emission spectrum of φ37×1430 mm pulsed high-power xenon flash lamp of the present invention measured with typical flash lamp discharge circuit.

### DETAILED DESCRIPTION OF THE PREFERRED EMBODIMENTS

The detailed description of the present invention is illustrated in the drawings.

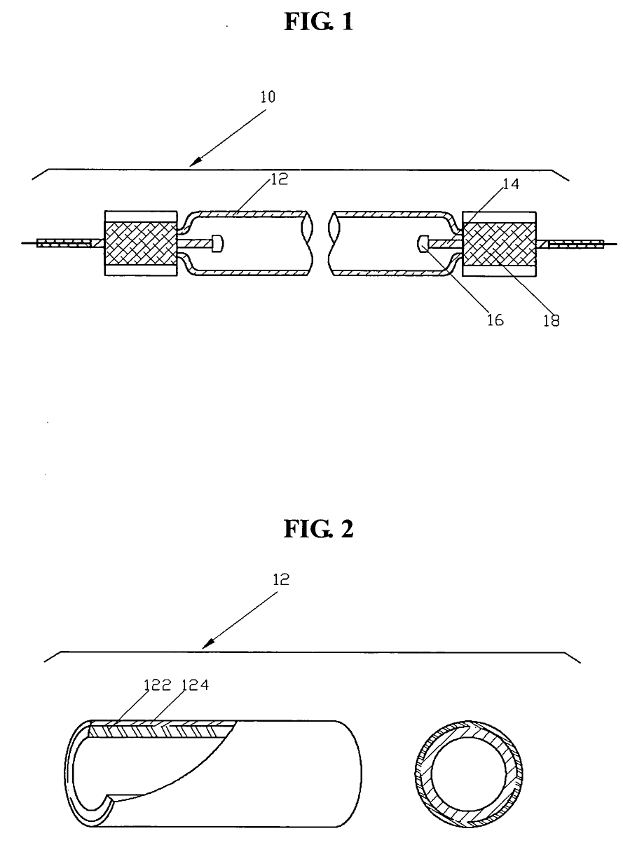

FIG. 1 illustrates a flash lamp embodiment of the present invention, referred to herein by the general reference number 10. The flash lamp 10 includes a compound quartz cylindrical envelope 12 that is necked down to a smaller diameter at both an anode end and a cathode end. An anode electrode 14 has a rounded and polished metal cap 16 and is sealed in envelope at seal assembly 18. Seal assembly 18 connects a wire 20. The characteristics of flash lamp 10 is that the quartz cylindrical envelope 12 is made of compound fused quartz glass tubes. Such a cylindrical envelope is critical to the present invention.

FIG. 2 shows schematic diagram of configuration of compound quartz tubes. The compound quartz cylindrical envelope 12 comprises pure fused quartz glass layer 122 and Ce-doped fused quartz glass layer 124. The concentration of Cerium ion in Ce-doped fused quartz glass layer 124 is uniform, or variational.

Seal assembly 18 described in FIG. 1 can be fabricated by the various kinds of technics, such as matched seal technics, non-matched seal technics.

A new kind of compound quartz tubes is used as the cylindrical envelope of flash lamp in the present invention. This kind of tubes has not only excellent mechanical properties can but also improve the emission spectrum of flash lamp. Flash lamp with different specifications can be fabricated by using this kind of compound quartz tubes with different diameter and thicknesses.

Practical use in large high-power solid-state lasers has proved that the flash lamp provided by the present invention has better mechanical properties and higher loading energy than flash lamp of the prior art and its emission spectrum which matches well absorption spectrum of Nd:glass.

There are four kinds of compound quartz tubes with different specifications which are used to make pulsed high-power flash lamp of the present invention in table 1.

### EXAMPLE 1

A pulsed high-power flash lamp is provided by the present invention comprises a cylindrical compound quartz tube flash lamp envelope that has an overall length of about 1670 millimeters (mm), an arc gap length of about 1430 mm, and an outer diameter of 37 mm. The flash lamp envelope is filled with highly pure xenon. Each cathode and anode electrode comprises a cerium-tungsten beaded rod. Seal assembly is quartz-to-quartz sealed to a ring perimeter of cathode and anode ends. Seal assembly connects with cables.

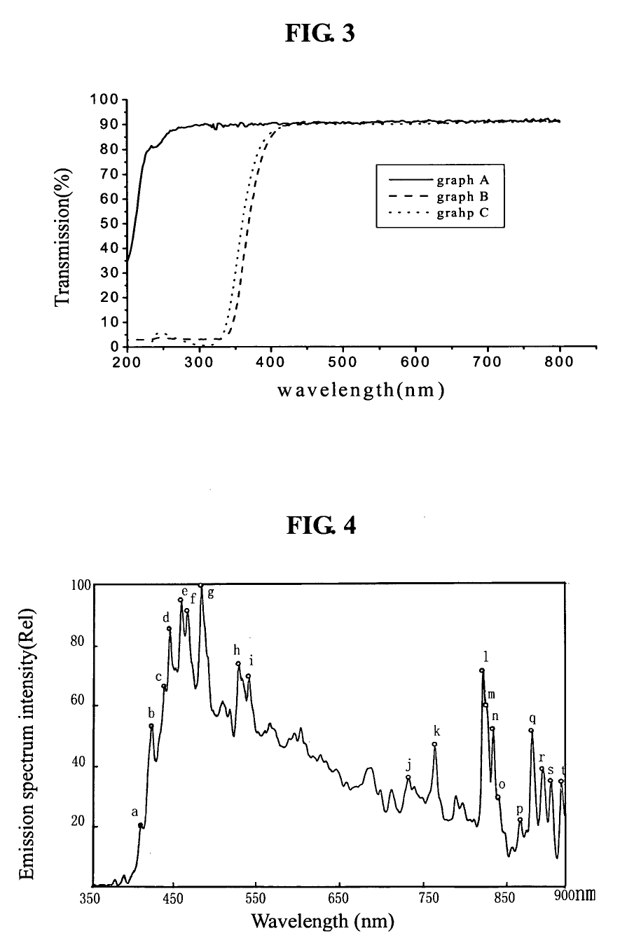

The compound quartz tube flash lamp envelope is fabricated with # 1 compound quartz tube in table 1, its thickness is 3 mm, the ratio of thickness of that of the pure quartz glass layer to Ce-doped quartz glass layer is 2:1. FIG. 3 is the transmission curves in the wavelength range from 200 nm to 800 nm in pure quartz glass bodies (A), in Ce-doped quartz glass bodies (B) and in compound quartz glass bodies applied in the present invention (C) are measured with UV/VIS/NIR spectrometer. FIG. 3 shows the transmission curve of compound quartz glass bodies applied in the present invention (C) in the wavelength range from 200 nm to 800 nm. It is similar to that of in Ce-doped quartz glass bodies (B) and the transmissivity in the wavelength range from 200 nm to 340 nm is below 5%.

FIG. 4 is emission spectrum of pulsed high-power flash lamp of the present invention tested by conventional flash lamp discharge circuit. FIG. 4 further demonstrates that pulsed high-power flash lamp of the present invention can absorb the ultraviolet radiation below 340 nm radiated by xenon plasma, so that the emission spectrum of pulsed compound quartz glass tube xenon flash lamp reaches 400 nm.

The ultimate energy of flash lamp provided by the present invention is tested, the result is Ex=141600J. The result indicates that the ultimate energy of flash lamp provided by the present invention is obviously higher than that of Ce-doped quartz tube flash lamp. The ultimate limit energy of Ce-doped quartz tube flash lamp is 124700J. According to empirical relationship N=(E₀/Eₓ)^{β},(β<0), the shot life of flash lamp provided by the present invention is longer than that of prior art Ce-doped quartz tube flash lamp.

Reliability of the compound quartz tube flash lamp provided by the present invention is checked by discharging in pump cavities. The result demonstrates that compound quartz tube flash lamp of Example 1 can operate for long time without explosion and failure at 23,000 volts. It is proved that the compound quartz tube flash lamp of Example 1 possesses excellent mechanical properties, high loading energy and appropriate emission spectrum that quite matches absorption spectrum of Nd:glass. So it can reach the pumping requirement of larger solid-state lasers.

### EXAMPLE 2

A pulsed high-power flash lamp provided by the present invention comprises a cylindrical compound quartz tube flash lamp envelope that has an overall length of about 1500 millimeters (mm), an arc gap length of about 1270 mm, and has an outer diameter of 22 mm, the flash lamp envelope is filled with highly pure xenon gas. The compound quartz tube flash lamp envelope is fabricated with #3 compound quartz tube in table 1, its thickness is 2.5 mm, the ratio of thickness of Ce-doped quartz glass layer, that of pure quartz glass layer to that of Ce-doped quartz glass layer is 0.5:1.0:0.5. This kind of the flash lamp is slim and xenon pressure is high, so it requires its envelope possess excellent mechanical properties. A batch of the flash lamps of Example 2 have been applied in larger solid-state lasers and operated by several hundreds shots without explosion. At the same time, these flash lamps strongly absorb ultraviolet radiation of xenon plasma below 340 nm without damaging Nd glass.

The flash lamps of Example 3 are made of #4 compound quartz in Table 1, the detailed description is same as Example 1 and no more need be explain in details here.

In short, pulsed high-power flash lamp provided by the invention has excellent mechanic properties, high loading energy and appropriate emission spectrum which quite matches absorption spectra of Nd:glass.

TABLE 1
The specifications of the compound quartz tubes

| | Thick- | | | |
|---|---|---|---|---|
| Com- | ness | | | Outside |
| pound | of | Number | | diameter |
| quartz | tubes/ | of | | of |
| tubes | mm | layers | Manner of array | tubes/mm |
| #1 | 3 | 2 | Inner layer is a pure quartz | 37 |
| | | | galss layer, outer layer is | |
| | | | Ce-doped fused quartz glass | |
| | | | layer | |
| #2 | 3 | 3 | Inner layer is a pure quartz | 37 |
| | | | galss layer, other two layers | |
| | | | are Ce-doped fused quartz | |
| | | | glass layers with different | |
| | | | concentrations of Cerium ion | |
| #3 | 2.5 | 3 | Inner layer is a Ce-doped | 22 |
| | | | fused quartz glass layer, | |
| | | | middle layer is a pure quartz | |
| | | | galss layer, outer layer is a | |
| | | | Ce-doped fused quartz glass | |
| | | | layer | |
| #4 | 3 | 4 | a pure quartz galss layer, a | 37 |
| | | | Ce-doped fused quartz glass | |
| | | | layer, a pure quartz galss layer, | |
| | | | a Ce-doped fused quartz glass | |
| | | | layer are alternately array. | |

1. A pulsed high-power flash lamp of the compound quartz glass tubes, comprising:
a quartz glass cylindrical envelope (12) with opposite anode and cathode ends; and
a quartz glass cylindrical envelope (12) necks down to a smaller diameter to accommodate a pair of re-entrant quartz glass seal assemblies (18), one with a cathode electrode and the other with an anode electrode;
wherein, both cathode and anode electrode comprise a beaded rod (14) and metal cap (16);
wherein, a quartz glass cylindrical envelope (12) is made of compound quartz tubes which comprises one or multilayer pure fused quartz glass layer and one or multilayer Ce-doped fused quartz glass layer.

2. A pulsed high-power compound quartz tube flash lamp according to claim 1, wherein pure fused quartz glass layer and Ce-doped fused quartz glass layer alternately arrayed.

3. The compound quartz glass tubes according to claim 2, wherein concentration of Cerium ion in Ce-doped fused quartz glass layer is uniform, or variational.

4. A pulsed high-power compound quartz tube flash lamp according to claim 1, wherein the compound quartz glass tubes comprises two layer quartz glass, inner layer is pure fused quartz glass layer and outer layer is Ce-doped fused quartz glass layer, or inner layer is Ce-doped fused quartz glass layer and outer layer is pure fused quartz glass layer.

5. A pulsed high-power compound quartz tube flash lamp according to claim 1, wherein the compound quartz glass tubes comprises one layer pure quartz glass layer and multilayer Ce-doped quartz glass layers, inner layer is pure fused quartz glass layer, and other layers are Ce-doped fused quartz glass layer.

6. A process for the manufacture a pulsed high-power compound quartz tube flash lamp according to claim 1, said process comprising:
1) Melting undoped and doped quartz raw material at a temperature at least 2000° C. in a oxyhydrogen flame or plasma flame according to layer configuration of a compound quartz glass tubes to form a compound quartz glass lump,
2) Heating the compound quartz glass lump in intermediate frequence furnace to manufacture compound quartz glass tubes,
3) Sealing a cathode electrode and a anode electrode in compound quartz glass tubes by sealed technics,
4) vacuumizing the compound quartz glass tubes and immitting gases to fabricate a pulsed high-power flash lamp.

7. A process according to claim 6, wherein seal technics comprises matched seal technics, non-matched seal technics.
